(19) United States
(12) Patent Application Publication
(10) Pub. No.: US 2023/0147933 A1
(43) Pub. Date: May 11, 2023

(54) DRIVE DEVICE

(71) Applicant: Rogama B.V., Valkenburg (NL)

(72) Inventor: Rob MATTI, Valkenburg (NL)

(21) Appl. No.: 17/771,279

(22) PCT Filed: Oct. 28, 2020
(86) PCT No.: PCT/EP2020/080238

§ 371 Date: Oct. 11, 2022

(30) Foreign Application Priority Data
Oct. 28, 2019 (DE) 10 2019 129 044.9

(51) Int. Cl. B66F 9/14

(52) U.S. Cl. CPC B66F 9/143

(57) ABSTRACT

The invention relates to a drive unit for a device for lifting and transporting loads, which is attached or to be attached to a further device. A drive device according to the invention for the lateral movement of at least two load lifting elements of a device for lifting and transporting loads for mounting on a movable or stationary device comprises a first drive element and a second drive element, wherein the first load lifting element is movable by the first drive element and the second load lifting element is movable by the second drive element laterally in the axial direction of a first guide profile of the device for lifting and transporting loads, wherein the at least two load lifting elements are supportable by the first guide profile. The two drive elements can be driven by exactly one drive unit, the exactly one drive unit being positioned between the two drive elements.

The invention relates to a drive device, in particular for a device for lifting and transporting loads, which is attached or is to be attached to a further device. This further device can be a stationary or movable device, where the movable device can be, for example, a vertically movable lifting carriage of an industrial truck.

Such devices for lifting loads can, for example, be integrated into an industrial truck or be designed as an attachment that is fastened or to be fastened to a device such as a forklift truck. They usually have two or more load lifting elements that are movable relative to each other, for example in the form of two fork arms that are movable relative to each other. This mobility of the forks is achieved by means of appropriately designed adjustment devices and enables the user to adapt the forks to the width of an object to be picked up or to recesses therein in which the forks engage.

In many cases, the load lifting elements can be moved not only toward and away from each other, but also both in parallel and simultaneously in the same direction to compensate for an inaccurate approach with the industrial truck without maneuvering with the entire vehicle. This sideshift movement is made possible by the same drive units as the movement of load lifting elements towards and away from each other. The respective adjustment devices are actuated by the operator of the industrial truck from the workstation without him having to dismount for this purpose.

Since such load-lifting devices are usually used intensively in relatively rough environments, the robustness of the design is an important criterion. The load to be picked up is always in direct contact with the device and protruding parts of the load or picking up the load too roughly can lead to damage.

From the German patent application DE 10 2011 002 433 (A1) a device for transporting loads is known, which comprises two load lifting elements, which are each mounted on horizontally movable sliding arms, which are movable relative to each other by drive elements, wherein the sliding arms are mounted on at least one sliding guide body and are movable along a sliding guide body by the drive elements. The load-lifting elements are additionally each mounted on movable guide arms which are guided on a guide rail, the sliding guide body and the guide rail being connected to one another by two connecting elements and spaced apart from one another. The drive elements are partially arranged inside the slide guide body and the slide arms are movably guided inside the slide guide body, wherein the slide guide body has a longitudinal slot through which a connecting portion of the slide arm protrudes and is connected to a load lifting element. During operation of the device, the major part of the respective driving element lies within the sliding guide body. The sliding guide body thus at least partially encloses both the drive elements and the sliding arms, so that these are advantageously accommodated protected in a sliding guide body which at the same time serves to guide the sliding arms. Damage and failure of the industrial truck can thus be reduced and maintenance costs remain low. At the same time, the device can be designed compact to provide the operator with a good view of the load lifting elements and to allow cost-effective manufacture. A disadvantage of this design is that two sliding guide bodies are positioned one above the other and restrict the view of the operator through the cross-section of an industrial truck despite the compactness of the design. Furthermore, the higher dead weight of this design is disadvantageous.

From the international patent application WO 2016/205 376 A1 a fork positioning device for mounting on a lift truck is known. The device has a first fork positioner and a second fork positioner, the fork positioners being connected to a fork frame. The first fork positioner is substantially mirror-symmetrical to the second fork positioner. Each fork positioner includes a tube having an internal cavity in which a piston and a carrier are disposed, both of which are coupled to a rod. The piston and the carrier are both in sliding contact with the tube. Each fork positioner has a fork holder disposed outside the tube, the fork holder being coupled to the carrier through a slot in the tube. The portion of the carrier coupled to the fork holder is located between a first carrier bushing and a second carrier bushing. Because of the fork frame, the fork positioning assembly has a quite large construction, reducing the clear cross-sectional area between the fork positioners and thus reducing the visibility for an operator of an industrial truck to which the fork positioning assembly is attached.

From the German patent application DE10 2017 213 236 A1 a device for lifting and transporting loads, which can be attached to a movable or stationary device, is known. A first guide profile element has a hollow profile element, in the interior of which a drive element is at least partially integrated. The drive element and the guide of a driver plate for a fork arm lie on one axis. With this design, a large see-through cross-section is already achieved. However, even with this design, the drive elements available on the market reduce the cross-sectional area of the operator's view.

It is therefore the task of the invention to provide a drive device for a lateral movement of load lifting elements, which can be connected to a device for lifting and transporting loads and with which the free cross-section for the view of an operator of the device for lifting and transporting loads is further maximized.

According to the invention, this task is solved by a drive device having the features of independent claim 1. Advantageous further developments of the drive device can be found in dependent claims 2 to 11.

An inventive drive device for the lateral movement of at least two load lifting elements of a device for lifting and transporting loads for mounting on a movable or stationary device comprises a first drive element and a second drive element, wherein a first load lifting element is movable by the first drive element and a second load lifting element is movable by the second drive element laterally in the axial direction of a first guide profile of the device for lifting and transporting loads. The at least two load lifting elements are supportable by the first guide profile. The two drive elements can be driven by exactly one drive unit, with the exactly one drive unit being positioned between the two drive elements. In other words, since the load lifting elements are drivable by the drive elements, the drive unit is also positioned between the load lifting elements. The drive device of the invention is characterized by the fact that the exactly one drive unit has an internal and continuous output shaft, the first output shaft end being operatively connected in a rotationally fixed manner to the first drive element and the second output shaft end being operatively connected in a rotationally fixed manner to the second drive element, and the axis of the output shaft and the axes of the drive elements lying on one line. The output shaft can be connected to the two drive elements, for example, at the center of the output shaft. The fact that the axis of the output shaft and the axes of the drive elements are in line makes the drive unit particularly compact. However, the axes of the drive elements can also be offset from one another. One drive element can be operatively connected, for example, to one gear wheel. This embodiment can be advantageous for special applications.

In this document, a drive unit is understood to mean a unit that is capable of driving the drive elements. For this purpose, the drive unit may comprise a motor and possibly other components, such as bearings, gearboxes, etc. The motor can be, for example, a hydraulic motor or an electric motor.

In this document, lateral movement of the load lifting elements is understood to mean movement of the load lifting elements towards or away from each other, i.e. in a direction transverse to a load lifting or load transport direction, as well as parallel movement of the load lifting elements transverse to a load lifting direction. Usually, the load lifting elements can be attached to a first guide profile, this first guide profile being arranged transverse to the transport and lifting direction of the loads and the lateral direction points in the direction of the first guide profile.

Since the two drive elements can only be driven by exactly one drive unit, the drive device is particularly compact.

In a further advantageous embodiment, at least one drive element has a spindle. Alternatively, each drive element can have a spindle with a different direction of rotation.

In a further advantageous embodiment, each of the two drive elements has a double spindle with a different direction of rotation.

In a further advantageous embodiment, each drive element can be operatively connected to at least one load lifting element. The operative connection can, for example, be a direct connection between the drive element and the at least one load lifting element. However, it is also possible for the operative connection to be established, for example, via an adapter piece in the form of e.g. a driver plate. The load lifting elements can simply be inserted into the driver plates, so that standard load lifting elements such as standard fork arms can be used, which can nevertheless perform lateral movements.

Furthermore, it has proven advantageous if the first guide profile has a hollow profile and a drive element is at least partially integrated in the first guide profile, the first guide profile having a longitudinal slot through which a holder for a load lifting element protrudes. Due to the at least partial integration of the drive element into the hollow profile, the drive element is protected against external influences and thus against damage.

In a further advantageous embodiment, the exactly one drive unit is at least partially integrated in the first guide profile in addition to a drive element. Due to the at least partial integration of the drive unit in the hollow profile, the drive unit is protected against external influences and thus against damage.

In a further advantageous embodiment, the exactly one drive unit comprises a gear wheel, wherein the gear wheel is drivable and operatively connected to the output shaft in a rotationally fixed manner. Due to this design, the exactly one drive unit is very compact, whereby the free cross-section for the view of an operator of the device for lifting and transporting loads is further maximized.

In an advantageous embodiment, at least one drive element comprises a spindle. For example, recirculating ball screws or threaded spindles may be used. The counterpart to the spindle can be a bushing to which a connecting element can be attached for connection to a load lifting element.

In a further advantageous embodiment, at least one drive element has a switchable gear for reversing the direction of movement of at least one load lifting element. This makes it possible for the lateral movement of load lifting elements to be in the same direction or in opposite directions, depending on the position of the gear. The opposing movement of the forks allows users to adjust the distance between the load lifting elements to the width of an object to be picked up or to recesses located therein in which the load lifting elements can engage. The parallel movement of the load lifting elements, which both move in the same direction, enables an imprecise approach with an industrial truck to a load to be picked up, where the parallel movement of the load lifting elements in the same direction enables the load to be picked up without maneuvering the entire vehicle.

In an advantageous embodiment, bearings are provided in the drive device that are designed to absorb lateral forces of the drive elements. The lateral forces of the drive elements can arise from the lateral thrust movement and are composed, for example, of inertial forces of the moving masses, friction and possibly forces due to the lateral displacement of loads with a load lifting element. By providing the bearings, such forces can be absorbed without putting stress on gear wheels or other components of the drive unit. The bearings can be provided at the respective ends of the drive elements.

Furthermore, it has proven advantageous if the drive unit has a housing, whereby axial forces of the drive elements can be transmitted via the housing to the device for lifting and transporting loads. The load transmission from the drive elements to the housing can take place, for example, via the bearings described above. Via the housing, the loads can be transferred to the overall structure, for example via a frame or other structural elements, without putting stress on movable functional elements of the drive device. Axial loads can occur, for example, when the load lifting elements are subjected to lateral loads during transport or when carrying loads.

In a further advantageous embodiment, the drive device has at least one first connecting element and one second connecting element for receiving the at least two load lifting elements, the first connecting element being operatively connectable to a first bushing and the second connecting element being operatively connectable to a second bushing with internal threads, the first bushing being operatively connected to the first drive element and the second bushing being operatively connected to the second drive element, the drive elements each having an end stop, a spring being provided between the bushings and the respective end stop. The connecting elements are moved laterally, for example, by rotation of the drive elements via bushings, where the lateral movements can be in opposite directions or in the same direction. The spring prevents the drive element from jamming in the bushing at the end stop. When the bushing moving on the spindle approaches an end stop, the spring first comes under pressure. The counterforce built up by the spring increases slowly as the bushing advances on the spindle, so that the bushing does not suddenly jam on the spindle, causing a high tension force in the thread of the spindle. In addition, the release force required later when the spindle is turned back to release the bushing is supported by the spring. In other words, the spring acts as a force accumulator. The spring can be arranged at the end stop on the spindle or in the bushing.

In one embodiment, at least one spring is installed for each direction of movement. If this one spring per direction of movement is installed in the opposite direction and provided with even a slight offset, so that both springs cannot be brought to the stop at the same time, only one spring brakes in each direction. Since the output shaft in the drive unit, which is non-rotatably connected to the drive elements, is continuous, the entire drive shaft and both drive elements brake. This means that one spring can be saved for each direction of movement, which means that the drive device requires less space and can be manufactured at low cost. All known suitable springs, such as helical, disc, coil, ring, gas pressure, rubber or air springs, can be used as springs.

It has also proved advantageous to arrange the spring in a chamber in the bushing. This prevents the spring from deflecting under load. In addition, the range of movement of the load lifting elements is maximized.

The drive unit can have a hydraulic motor, for example. In this case, a hydraulic fluid flows under pressure into a chamber in which the two gear wheels are arranged so that they can rotate and mesh with each other. As in a gear pump, the gears are arranged in the chamber in such a way that they can rotate with little play in the chamber housing. The hydraulic fluid presses on two gear flanks in the direction of rotation and one gear flank against the direction of rotation. The hydraulic fluid is guided to the discharge side in chambers formed between the gear flanks and the housing wall. Thus, such a hydraulic motor has a very compact design, so that the free cross-section for the view of an operator of the device for lifting and transporting loads is further maximized The use of a hydraulic motor is particularly advantageous when using the drive unit on an industrial truck, since industrial trucks usually have a hydraulic power unit for driving further actuators, so that pressurized hydraulic fluid is available as a standard on the industrial truck.

It has proven to be advantageous if the hydraulic motor has one port each for the supply and return of the hydraulic fluid, with the ports pointing to the same side of the hydraulic motor. This also allows the connection lines to be laid in such a way that the view of the operator of the device for lifting and transporting loads is not restricted.

Alternatively, the drive unit can have an electric motor. The electric motor does not require ports for the supply and return of the hydraulic fluid, so that the view of the operator of the device for lifting and transporting loads is even less restricted.

It has further proved to be advantageous if the first guide profile has a receiving profile with a projecting ledge on one of its outer sides, wherein the at least one load lifting element can be suspended in the receiving profile by means of a suspension profile machined mirror-symmetrically to the receiving profile, wherein the suspension profile has a sliding piece which bears against the projecting ledge of the receiving profile when the load receiving element is suspended in the receiving profile. The load lifting elements can be suspended in the upper guide profile, being supported by the upper guide profile and by the lower guide profile. The sliding piece minimizes friction during lateral adjustment of the load lifting element, which means that less energy is required for lateral adjustment of the load lifting element and wear is minimized.

It has proved to be particularly advantageous if only one guide profile has a drive element.

It has also proved advantageous if at least the first guide profile surrounds more than half of the drive element arranged in its interior. Furthermore, it has been found to be particularly advantageous if the degree of encompassing is more than 75%. As the drive element is encompassed by the guide profile, the drive element lies protected in the guide profile and is held by the latter in such a way that it cannot bend or buckle even when great force is applied.

Further advantages, special features and expedient further embodiments of the invention result from the dependent claims and the following illustration of preferred examples of embodiment on the basis of the figures.

### IN THE FIGURES

FIG. 1 shows a three-dimensional representation of a drive device with load lifting elements in a position of maximum width

FIG. 2 shows a three-dimensional representation of a drive device with load lifting elements in a maximally narrow position

FIG. 3 shows a three-dimensional representation of a drive device with connecting elements in a position of maximum width

FIG. 4 shows a three-dimensional representation of a drive device with load lifting elements in an intermediate position

FIG. 5 shows a three-dimensional representation of a drive device in a sectional view

FIG. 6 shows a sectional plan view of a drive device

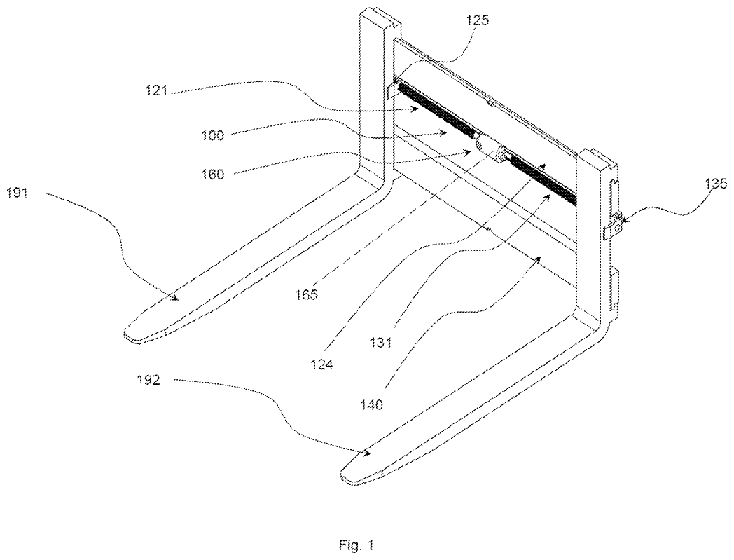

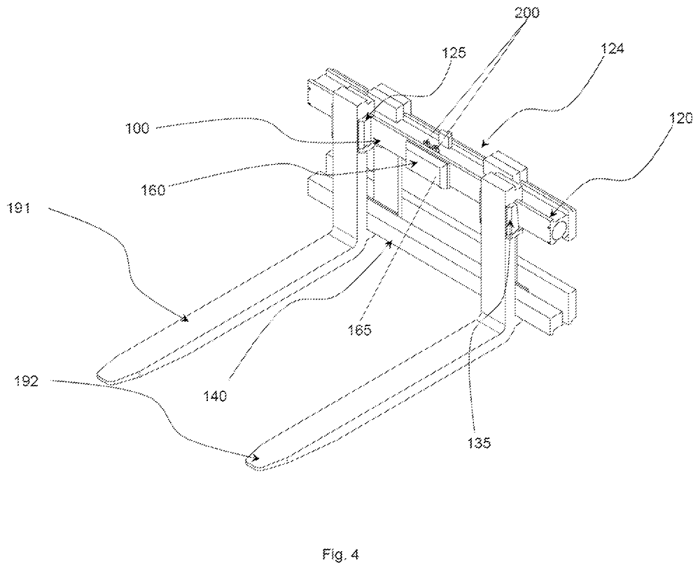

FIG. 1 shows a three-dimensional representation of a drive device 100 with load lifting elements 191, 192 suspended in connecting elements 125, 136. The first and second drive elements are located on a plane and, in this embodiment, below a first guide profile 120 (not shown in FIG. 1, see FIGS. 4, 5 and 6) and a fork carrier bar 124, respectively, on which the drive device 100 is mounted. Alternatively, the drive device may also be arranged above the first guide profile 120. Furthermore, the drive device can also be integrated in the lifting frame (not shown) of an industrial truck by connecting the mast cheeks of the industrial truck (not shown) directly to the frame structure, which means that a fork carrier bar can be dispensed with. The load lifting elements 191, 192 are suspended from the first guide element 120 and are supported by the latter. The load lifting elements 191, 192 are also supported by a second guide profile 140. Between the first drive element 121 and the second drive element 131 there is a drive unit 160 in a housing 165. This drive unit 160 can be, for example, an electric motor or a fluid motor, for example a hydraulic motor. The drive unit 160 rotationally drives both the first drive element 121 and the second drive element 131, which are located on a continuous shaft. The drive elements 121, 131 are spindles, for example recirculating ball screws or threaded spindles. Bushings 121h, 131h, to which connecting elements 125, 135 are attached, are moved via the drive elements 121, 131. Integrated in the drive elements 121, 131 can be gears (not shown in the Fig.), which are switchable and can reverse the direction of rotation of a drive element 121, 131, so that both a sideshift movement, in which the connecting elements 125, 135 are moved in parallel and in the same direction, and an opposite direction movement of the connecting elements 125, 135, as required for adjusting the distance of the load lifting elements 191, 192, are possible. In FIG. 1, the connecting elements 125, 135 and thus the load lifting elements 191, 192 are in the position of maximum width.

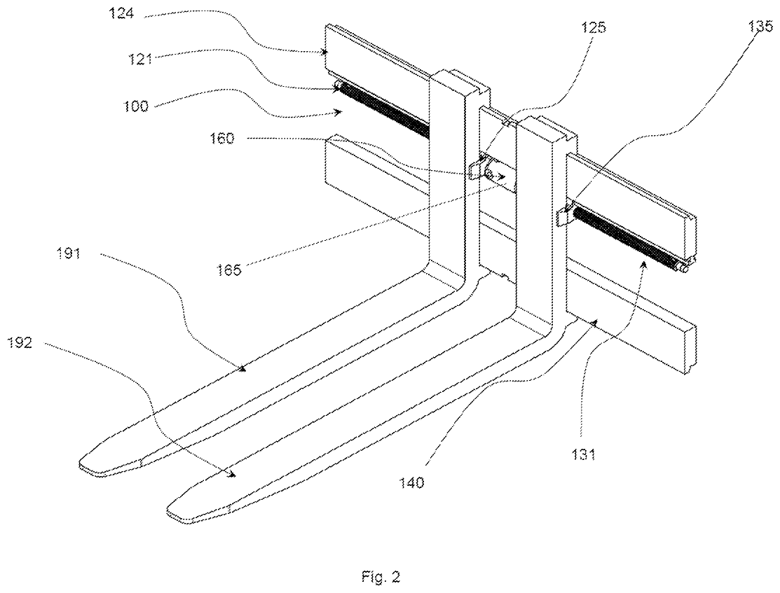

In FIG. 2, the drive device 100 from FIG. 1 is shown in a maximally narrow position. The two connecting elements 125, 135 are therein moved up to a stop (not shown) on the drive unit 160.

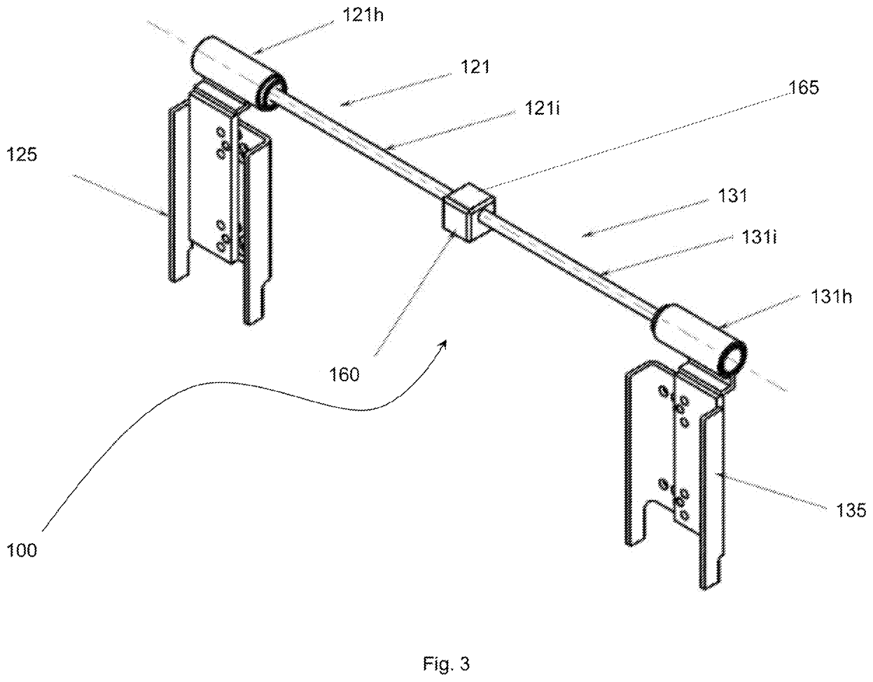

FIG. 3 shows a drive device 100 according to the invention with connecting elements 125, 135 in a position of maximum width in a three-dimensional representation detached from an assembly situation. The connecting elements 125, 135 are attached to the bushings 121h, 131h driven by the drive elements 121, 131. The drive unit 160 is arranged centrally between the bushings 121h, 131h.

FIG. 4 shows a further three-dimensional representation of a drive device 100 with load lifting elements in connecting elements 125, 135 in an intermediate position. The drive elements 121, 131 are integrated into the first guide element 120, which is designed as a hollow profile, and are therefore not visible in this illustration. Due to the integration into the first guide profile 120, the drive elements 121, 131 are protected against damage to the greatest possible extent. The drive unit 160 of this embodiment has a hydraulic motor. The hydraulic connections 200 point upwards out of the first guide profile 120 through openings in the housing 165, so that the hydraulic connections 200 and hydraulic hoses attached thereto (not shown) do not interfere with the load lifting and also the free view for an operator of a device for lifting and transporting loads, on which the drive device is mounted, is not restricted.

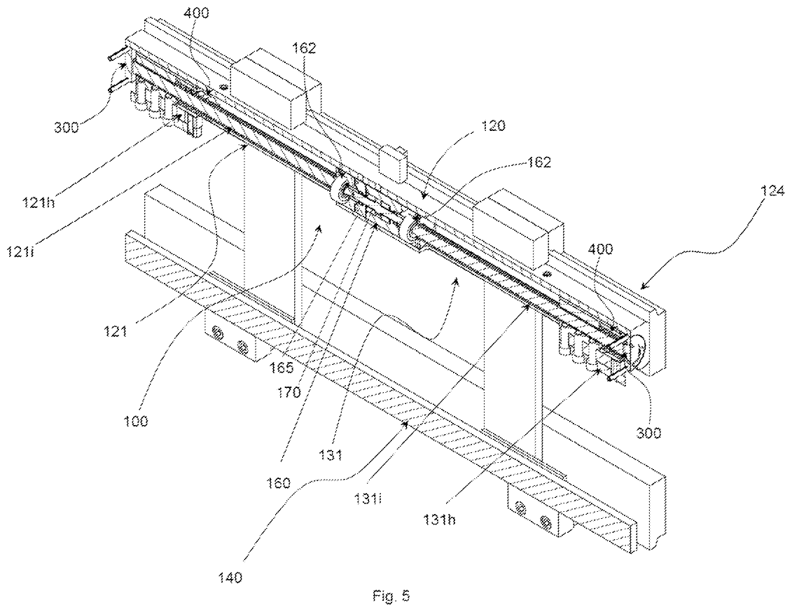

FIG. 5 shows a three-dimensional cross-sectional view of a drive device 100. Bearings 162 are provided in the drive unit 160, which are designed to absorb lateral forces of the drive elements 121, 131. The lateral forces of the drive elements 121, 131 can result from the sideshift movement and are composed, for example, of inertial forces of the moved masses, friction and possibly forces due to the lateral displacement of loads with a load lifting element 191, 192. By providing bearings 162, such forces can be absorbed. The drive unit 160 has a housing 165, where axial forces of the drive elements 121, 131 can be transmitted via the housing 165 to the device for lifting and transporting loads on which the drive device 100 is mounted. The first connecting element 121 has a first bushing 121h and the second connecting element 131 has a second bushing 131h with an internal thread, the first bushing 121h being operatively connected to the first drive element 121 and the second bushing 131h being operatively connected to the second drive element 131, the drive elements 121, 131 each having an end stop 300, a spring 400 being provided between the bushings 121h, 131h and the respective end stop 300. Connecting elements 125, 135 can be fastened to the bushings 121h, 131h and can be moved laterally, for example by rotation of the drive elements 121, 131 via the bushings 121h, 131h, where the lateral movements can take place in opposite directions or in the same direction. The spring 400 can be used to prevent the respective drive element i121, 131 from jamming in the respective bushing 121h, 131h on the end stop 300. If the bushing 121h, 131h moving on the respective spindle 121i, 131i approaches an end stop 300, the spring 400 first comes under pressure. The counterforce built up by the spring 400 grows slowly with further progress of the respective bushing 121h, 131h on the respective spindle 121i, 131i, so that the bushing 121h, 131h on the spindle 121i, 131i does not suddenly jam, thereby applying a high tension force in the thread of the spindle 121i, 131i. In addition, the release force required later when the spindle 121i, 131i is turned back to release the bushing 121h, 131h is supported by the spring 400. In other words, the spring 400 acts here as a force accumulator. The spring 400 may be arranged at the end stop 300 on the spindle 121i, 131i and/or partially in the bushing 121h, 131h. In the embodiment shown in the figure, the spring 400 in the first drive element 121 is arranged on the spindle 121i in such a way that it can engage between the drive element 160 and the bushing 121h, while the spring 400 in the second drive element 131 is arranged in the bushing 131h in such a way that it can engage between the bushing 131h and the end stop 300.

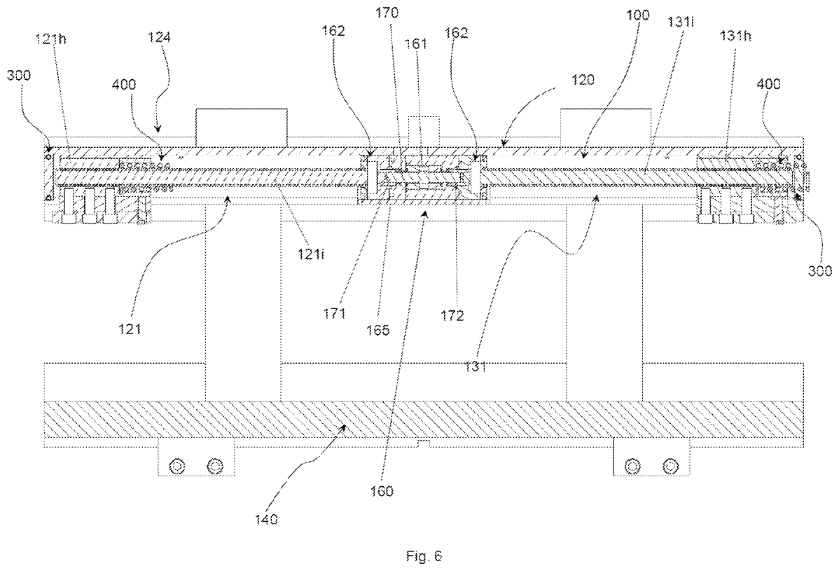

FIG. 6 shows a sectional view of an embodiment of the drive device 100 of FIG. 5 in a plan view. The drive unit 160 has a gear wheel 161 on an output shaft 170, via which the output shaft 170 can be driven. The output shaft 170 has a first output shaft end 171, via which the output shaft 170 is connected to the first drive element 121 in a rotationally fixed manner. Furthermore, the output shaft 170 has a second output shaft end 172, via which the output shaft 170 is connected to the second drive element 131 in a rotationally fixed manner. The drive unit 160 has two bearings 162, via which lateral forces introduced by the drive elements 121, 131 are absorbed by the housing 165 without putting stress on the gear wheel 161 or other components of the drive unit 160. One spring 400 is installed for each direction of movement. Both springs 400 are installed in opposite directions and are also provided with only a slight offset, so that both springs 400 cannot be brought to a stop at the same time. As a result, only one spring 400 brakes in each direction. Since the output shaft 170 in the drive unit 160 is continuous, the entire output shaft 170 and thus the two drive elements 121, 131 brake in each direction of movement when a stop 300 is approached. In the embodiment shown, helical springs are used as springs 400. In principle, all known suitable springs 400, such as helical, disc, coil, ring, gas pressure, rubber or air springs can be used.

### LIST OF REFERENCE NUMBERS

100 drive device
120 first guide profile
121 first drive element
121h first bushing
121i first spindle
124 fork carrier bar
125 first connecting element
131 second drive element
131h second bushing
131i second spindle
135 second connecting element
160 drive unit
161 gear wheel
162 bearing
165 housing
170 output shaft
171 first output shaft end
172 second output shaft end
191 first load lifting element, first fork arm
192 second load lifting element, second fork arm
200 hydraulic port
300 end stop
400 spring

1. Drive device for the lateral movement of at least two load lifting elements of a device for lifting and transporting loads for mounting on a movable or stationary device, comprising a first drive element and a second drive element, wherein a first load lifting element is movable by the first drive element and a second load lifting element is movable by the second drive element laterally in the axial direction of a first guide profile of the device for lifting and transporting loads, wherein the at least two load lifting elements can be carried by the first guide profile, wherein the two drive elements can be driven by exactly one drive unit, wherein the exactly one drive unit is positioned between the two drive elements,
the exactly one drive unit having an internal and continuous output shaft, the first output shaft end being operatively connected in a rotationally fixed manner to the first drive element and the second output shaft end being operatively connected in a rotationally fixed manner to the second drive element, and the axis of the output shaft and the axes of the drive elements lying on one line,
wherein
in addition, the exactly one drive unit is at least partially integrated in the first guide profile.

2. Drive device according to claim 1,
wherein
at least one drive element has a spindle or each drive element has a spindle with a different direction of rotation.

3. Drive device according to claim 1,
wherein
each of the two drive elements has a double spindle with a different direction of rotation.

4. Drive device according to claim 1,
wherein
each drive element can be operatively connected to at least one load lifting element.

5. Drive device according to claim 1,
wherein
the first guide profile comprises a hollow profile and in the first guide profile a drive element is at least partially integrated, wherein the first guide profile comprises a longitudinal slot through which a holder for a load lifting element protrudes.

6. Drive device according to claim 1,
wherein
the exactly one drive unit has a gear wheel, which gear wheel can be driven and which gear wheel is operatively connected in a rotationally fixed manner to the output shaft.

7. Drive device according to claim 1,
wherein
at least one drive element has a shiftable gear for reversing the direction of movement of at least one load lifting element.

8. Drive device according to claim 1,
wherein
bearings are provided in the drive device, which are designed to absorb lateral forces of the drive elements.

9. Drive device according to claim 1,
wherein
the drive unit has a housing, wherein axial forces of the drive elements can be transmitted via the housing to the device for lifting and transporting loads.

10. Drive device according to claim 1,
wherein
the drive device has at least one first connecting element and one second connecting element for receiving the at least two load lifting elements, where the first connecting element can be operatively connected to a first bushing and the second connecting element can be operatively connected to a second bushing having internal threads, the first bushing being operatively connected to the first drive element and the second bushing being operatively connected to the second drive element, the drive elements each having an end stop, a spring being provided between the bushings and the respective end stop.
